(19) United States
(12) Patent Application Publication
(10) Pub. No.: US 2023/0206036 A1
(43) Pub. Date: Jun. 29, 2023

(54) Method for generating a decision support system and associated systems

(71) Applicants: THALES, Courbevoie (FR); Centre national de la recherche scientifique, Paris (FR); UNIVERSITE PARIS-SACLAY, Gif Sur Yvette (FR); SCIENTIFIQUE, PARIS (FR)

(72) Inventors: Christophe LABREUCHE, Palaiseau Cedex (FR); Roman BRESSON, Palaiseau Cedex (FR); Martine SEBAG, Villejuif (FR); Johanne COHEN, (FR)

(21) Appl. No.: 18/008,298

(22) PCT Filed: Jun. 4, 2021
(86) PCT No.: PCT/EP2021/064992

§ 371 Date: Dec. 5, 2022

(30) Foreign Application Priority Data
Jun. 5, 2020 (FR) FR2005894

(51) Int. Cl. G06N 3/048; G06N 3/045

(52) U.S. Cl. CPC G06N 3/048; G06N 3/045

(57) ABSTRACT

The present invention relates to a method for generating a multiple-criteria decision support system comprising:
providing a problem and training data solving the problem for specific cases, the problem being a problem of evaluating the quality of a system chosen from:
choosing the best alternative from among alternatives,
distributing alternatives among classes,
the storage of alternatives in order of preference, and
providing a score of an alternative,
re-transcribing the problem according to a neural network and constraints to be observed,
training the re-transcribed neural network using the training data,
the determination of the function performed by the trained neural network, and
physically implementing the determined function in order to obtain the support system.

The present invention relates to a method for generating a decision support system The present invention further relates to decision support systems associated with the generation method.

Decision support, and more precisely multiple-criteria decision support, is a vast field the applications of which belong to multiple and varied fields, such as air traffic control, border surveillance or medicine.

Such an area consists of developing models aiming to guide decision-makers (whether experts or not) to solve various problems relating to the decisions the decision-makers would have to make, and in particular how to deal with the different alternatives suitable for the situation considered.

Such problems include, in particular, classification problems (arranging alternatives in classes each corresponding to a level of satisfaction), sorting problems (sorting alternatives in the order of the decision-maker's preferences), choice problems (choice of the best alternative from all alternatives) and evaluation problems (providing an overall score to an alternative)

To be effective, the models developed are suitable for reproducing the decision-making strategies of the decision-maker as faithfully as possible, and for providing the decision-maker with indicators on the proposed choice in order to justify the outputs thereof. Hereinafter, such models are called preference models.

It is thus desirable to be able to determine parameters of a preference model using an elicitation step of the preference model, knowing that this procedure is used for solving a problem of classification, sorting or choice.

Usually, the development of preference model parameters requires sustained interaction between the decision-maker (end user who will be helped by the model) and the model designers. The designers ask the expert to give so-called “preferential” information which will depend on the preference model and the sets of possible parameters. Questions are usually determined artificially by designers in order to extract the maximum amount of information.

Such information, which can be of various natures (preferences between two alternatives, relative importance of two criteria), is used in parallel with the interaction through linear programming or optimization techniques so as to determine the optimal parameters of the preference model.

Such an ideal situation is not however, always possible in practice, in particular because of the limited time the decision-maker has, and there are cases where, the designer has data for determining the preference model.

Such data is e.g. derived from a collection of feedback from a system operator, on the recommendations made to the system operator. One of the problems is that the data can be vitiated by uncertainty (noise on the data e.g.) and can contain errors (e.g. in the labelling of the data).

A method for generating a decision support system is thus needed, which would allow a quality decision support system to be obtained with very little intervention from the decision-maker, ideally only using training data.

To this end, the present description proposes a method of generating a multiple-criteria decision support system, the method of generation comprising the provision of an initial problem and training data solving the initial problem for particular cases, since the initial problem is a problem of evaluating the quality of the existing system or of the system to be created, the initial problem being a problem chosen from the choice of the best alternative among a set of alternatives, the distribution of alternatives among classes of preferences, the ordering of alternatives in an order of preference, and providing an evaluation score of an alternative. The generation method further comprises the transcription of the initial problem in the form of a neural network and a set of constraints the neural network has to satisfy in order to obtain a transcribed neural network, the training of the neural network which is transcribed using the training data, so as to obtain a trained neural network solving the initial problem, the determination of the function performed by the trained neural network, and the physical implementation of the determined function for obtaining the decision support system.

According to particular embodiments, the generation method comprises one or a plurality of the following features, when technically possible:
the transcribed neural network comprises a set of neural sub-networks, the transcription step comprising the formulation of the set of constraints to be satisfied by the neural network in the form of sub-constraints to be satisfied by each neural sub-network.
each neural sub-network includes hidden layers, the number of hidden layers being less than or equal to 5, preferentially less than or equal to 3.
the sub-constraints to be satisfied by a neural sub-network are chosen from the list consisting of the monotonicity of the variation of the output of the neural sub-network as a function of the inputs of the neural sub-network, of the output of the neural sub-network which is comprised between a minimum value and a maximum value, the output of the neural sub-network being equal to the minimum value when all inputs of the neural sub-network are equal to the minimum value, and the output of the neural sub-network being equal to the maximum value when all the inputs of the neural sub-network are equal to the maximum value, and of each sub-network which is suitable for implementing weights, one constraint being that the weights have to be positive and that the sum of the weights has to be equal to 1.
the transcribed neural network includes a set of neural sub-networks arranged in a tree structure, each neural sub-network being a first neural sub-network or a second neural sub-network, each first neural sub-network performing a respective aggregation function, the aggregation function preferentially being an aggregation function with variables selected from the list consisting of a weighted sum of variables, a Choquet integral, a 2-additive Choquet integral, a weighted sum of combinations of min and max functions between k variables, for k at least equal to 2, of a multi-linear model, of a generalized additive independence function, and of the ordered weighted average, and each second neural sub-network performing a respective marginal utility function, the marginal utility function preferentially being a monotone function or a function having three parts, a monotone first part, a constant second part, and monotone third part, the monotonicity of the first part being different from the monotonicity of the third part.
training includes a first training with the set of constraints of the transcription, for training an intermediate neural network, a second training of the set of constraints by setting the neural network at the intermediate neural network, so as to obtain a learned set of constraints, and an adjustment of the trained neural network according to the difference between the set of constraints of the transcription and the learned set of constraints, so as to obtain an adjusted neural network, the trained neural network being the adjusted neural network.
training includes the use of at least one technique chosen from the list consisting of batch gradient descent, stochastic gradient descent and mini-batch gradient descent.
training comprises the use of a weighted sum of sigmoids.

The present description further relates to a decision support system, in particular a multiple-criteria decision support system, generated by implementing a generation method as described hereinabove.

The present description further relates to a decision support system, in particular a multiple-criteria decision support system, the support system comprising a physical implementation of a neural network comprising a set of neural sub-networks arranged in a tree structure, each neural sub-network being a first neural sub-network or a second neural sub-network, each first neural sub-network performing a respective aggregation function, the aggregation function preferentially being a variable aggregation function selected from the list consisting of a weighted sum of the variables, a Choquet integral, a 2-additive Choquet integral, a weighted sum of combinations of min and max functions between k variables, for k at least equal to 2, of a multi-linear model, of a generalized additive independence function, and of the ordered weighted average, and each second neural sub-network performing a respective marginal utility function, the utility function preferentially being a monotone function or a function having three parts, a monotone first part, a constant second part, and monotone third part, the monotonicity of the first part being different from the monotonicity of the third part.

Other features and advantages of the invention will appear upon reading hereinafter the description of the embodiments of the invention, given only as an example, and making reference to the following drawings:

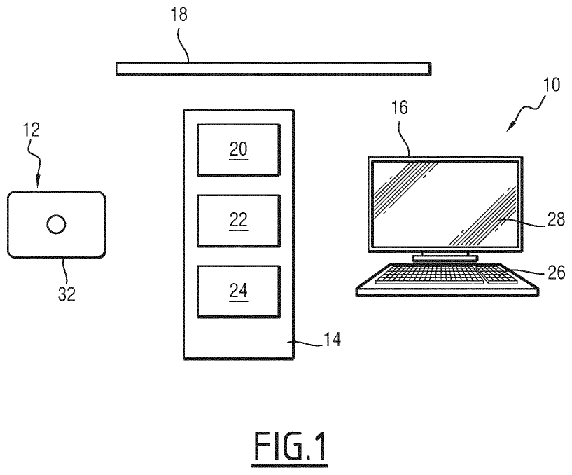

FIG. 1, a schematic representation of a computer and computer program product suitable for implementing a method for generating a decision support system,

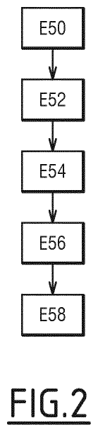

FIG. 2 is a flowchart of an example of implementation of a method for generating a decision support system,

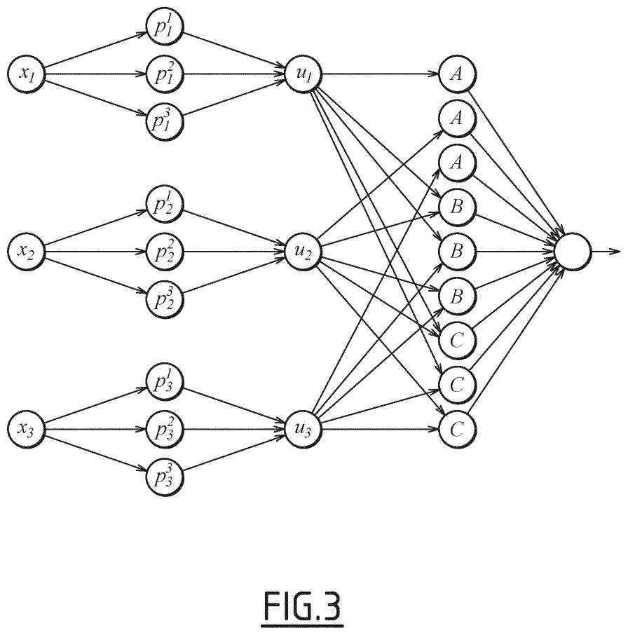

FIG. 3, a schematic representation of an example of a neural network used in the generation method shown in FIG. 2,

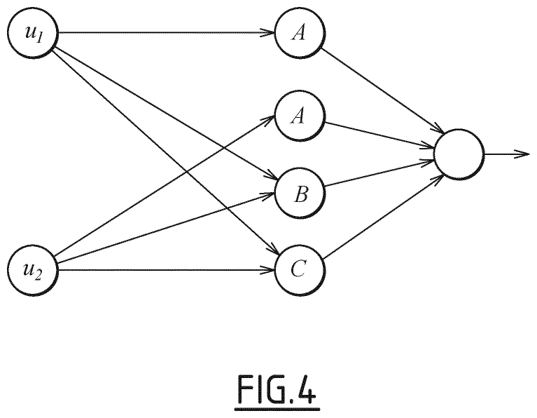

FIG. 4, a schematic representation of an example of a neural sub-network which could be used in the generation method shown in FIG. 2, and

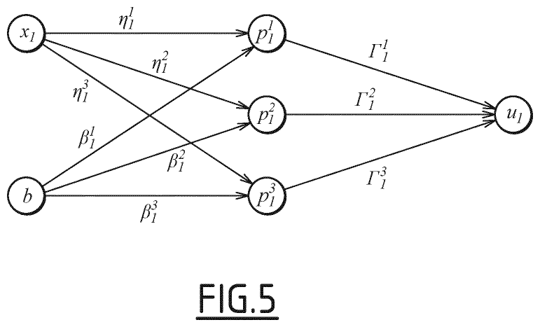

FIG. 5, a schematic representation of another example of a neural sub-network which could be used in the generation method shown in FIG. 2.

A computer 10 and a computer program product 12 are shown in FIG. 1.

The interaction between the computer 10 and the computer program product 12 a method for generating a decision support system to be implemented. The generation method is thus a method implemented by a computer.

The computer 10 is a desktop computer. In a variant, the computer 10 is a computer mounted on a rack, a laptop, a tablet, a personal digital assistant (PDA) or a smartphone.

In the above sense, the computer 10 can be seen as a system and can be designated interchangeably as such hereinafter.

In specific embodiments, the computer is suitable for operating in real time and/or is in an on-board system, in particular in a vehicle such as an aircraft.

In the case shown in FIG. 1, the computer 10 comprises a calculation unit 14, a user interface 16 and a communication device 18.

More generally, the computer 14 is an electronic computer suitable for handling and/or transforming data represented as electronic or physical quantities in registers of the computer 10 and/or memories into other similar data corresponding to physical data in the register memories or other types of displays, transmission devices or storage devices.

As specific examples, the computing unit 14 comprises a single-core or multi-core processor (such as a central processing unit (CPU), a graphics processing unit (GPU), a microcontroller and a digital signal processor (DSP)), a programmable logic circuit (such as an application specific integrated circuit (ASIC), an array of field programmable gates (FPGAs), a programmable logic device (PLD) and programmable logic arrays (PLAs), a state machine, a logic gate, and discrete hardware components.

The computing unit 14 comprises a data processing unit 20 suitable for processing data, in particular by performing calculations, memories 22 suitable for storing data and a reader 24 suitable for reading a computer-readable medium.

The user interface 16 comprises an input device 26 and an output device 28.

The input device 26 is a device which allows the user of the system 10 to enter information or commands into the system 10.

In FIG. 1, the input device 26 is a keyboard. In a variant, the input device 26 is a pointing device (such as a mouse, a touchpad and a graphics tablet), a voice recognition device, an eye sensor or a haptic device (movement analysis).

The output device 28 is a graphical user interface, i.e. a display unit designed for supplying information to the user of the computer 10.

In FIG. 1, the output device 28 is a display screen for a visual presentation of the output. In other embodiments, the output device is a printer, an augmented and/or virtual display unit, a loud-speaker, or other sound generating device for presenting the output in an audio form, a unit producing vibrations and/or odors or a unit suitable for producing an electrical signal.

In a specific embodiment, the input device 26 and the output device 28 are the same component forming human-machine interfaces, such as an interactive display.

The communication device 18 can be used for unidirectional or bidirectional communication between the components of the computer 10. The communication device 18 is e.g. a bus communication system or an input/output interface.

The presence of the communication device 18 allows in certain embodiments the components of the computing unit 14 to be spaced apart from each other.

The computer program product 12 comprises a computer-readable medium 32.

The computer-readable medium 32 is a tangible device readable by the reader 24 of the computing unit 14.

In particular, the computer-readable medium 32 is not a transient signal per se, such as radio waves or other freely propagating electromagnetic waves, such as light pulses or electronic signals.

Such a computer-readable storage medium 32 is e.g. an electronic storage device, a magnetic storage device, an optical storage device, an electromagnetic storage device, a semiconductor storage device, or any combination thereof.

As a non-exhaustive list of more specific examples, the computer-readable storage medium 32 is a mechanically encoded device, such as punched cards or relief structures in a groove, a diskette, a hard disk, a read-only memory (ROM), a random-access memory (RAM), an erasable read-only memory (EROM), an electrically erasable and readable memory (EEPROM), a magneto-optical disk, a static random-access memory (SRAM), a compact disk (CD-ROM), a digital versatile disk (DVD), an USB key, a floppy disk, a flash memory, a solid state drive (SSD) or a PC card such as a PCMCIA memory card.

A computer program is stored on the computer-readable storage medium 32. The computer program includes one or a plurality of sequences of stored program instructions.

Such program instructions, when executed by the data processing unit 20, lead to the execution of steps of the generation method.

The form of program instructions is e.g. a source code form, a computer-executable form, or any intermediate form between a source code and a computer-executable form, such as the form resulting from the conversion of the source code via an interpreter, an assembler, a compiler, a linker, or a locator. In a variant, the program instructions are a microcode, firmware instructions, state definition data, integrated circuit configuration data (e.g. VHDL), or an object code.

Program instructions are written in any combination of one or a plurality of languages, e.g. an object-oriented programming language (FORTRAN, C++, JAVA, HTML), a procedural programming language (C e.g.).

Alternatively, the program instructions are downloaded from an external source via a network, as is the case, in particular, for applications. In such case, the computer program product comprises a computer-readable data carrier on which the program instructions are stored or a data carrier signal on which the program instructions are encoded.

In each case, the computer program product 12 comprises instructions which can be loaded into the data processing unit 20 and are suitable for triggering the execution of the generation method when same are executed by the data processing unit 20. According to the embodiments, the execution is entirely or partially performed either on the computer 10, i.e. a single computer, or in a system distributed between a plurality of computers (in particular via the use of cloud computing).

The operation of the computer 10 is now described with reference to FIG. 2 which is a flowchart illustrating an example of the implementation of the method for generating a decision support system, in particular a multiple-criteria decision support system.

The generation method is a method for developing or manufacturing a decision support system.

On the basis of a multiple-criteria decision problem, the generation method allows a decision support system to be obtained for providing a solution to the problem, the system being apt to be used by a decision-maker.

The work of the decision support system designer is to transform the data of the problem into a physical system which is a decision support system.

The decision support system is often a computer 10 or part of the latter.

Such a decision support system can be used in many industrial applications.

In particular, the decision support system is a system for evaluating the operational quality of an existing physical system.

The decision support system is e.g. a system for evaluating the operation of an air traffic tracking system. The criteria relate herein to measures of the quality of tracking, such as aircraft location error. The decision support system is then suitable for providing an overall evaluation, or a class (level of quality of service).

In another example, the decision support system is a system which assists in evaluating the operation of a transport infrastructure, such as a train line or a metro line. In the event of a major incident involving delays, the decision support system allows the best solution to be proposed among all possible solutions such as changing train schedules or creating loops on the line.

According to another example, the decision support system is a design system of a physical system to be developed.

As an illustration, the decision support system is a design system of a set of a plurality of parts, such as a radar. Starting from the preferences of the designer of the radar, the decision support system then seeks to identify the best compromise between a plurality of criteria such as measures of the overall quality of the radar, the performance, the weight or the cost of the radar.

Thereafter, it is assumed that an initial problem to be solved has been defined.

The decision support system is intended to help the decision-maker find the best solution to the initial problem.

Hereinafter, such a solution is called an alternative, so that an alternative is an answer to the initial problem.

Thus, the decision support system is a physical implementation of a decision model suitable for the situation targeted by the initial problem, the decision model taking inputs for obtaining an output.

The initial problem is e.g. defined in two phases.

The first phase consists of a discussion with the decision-maker. The purpose is to fully characterize the problem to be solved from a “high level” point of view.

In such a phase, three points are identified, namely the form of the criteria, the nature of the problem and the available data.

The first point determined is the form of the criteria on which each of the alternatives will be evaluated.

The form of a criterion is the variation of the monotonicity of the model with respect to the criterion.

Within such context, monotonicity is the direction of evolution of the output in relation to one of the input criteria, all things otherwise being equal. Let us take the model M(a)=M(a1, . . . , an), with a1 to an, being the values of the alternative a over the n criteria. It is assumed that M is increasing (decreasing respectively, or increasing then decreasing, or decreasing then increasing) with respect to criterion 1. If criteria 2 to n are then set to arbitrary values, the function F which associates a real x with M(x, a2, . . . , an), is increasing (decreasing respectively, or increasing then decreasing, or decreasing then increasing).

In the example of the design of a radar system, the overall satisfaction is increasing with respect to the performance criterion such as the range of the radar (the farther the radar sees, the better, all things otherwise being equal), and the overall satisfaction is decreasing with respect to the electrical consumption (the less electricity the radar consumes, the better, all things otherwise being equal).

Otherwise formulated, the first point consists of asking whether the output of the model is increasing, decreasing, increasing then decreasing, or decreasing then increasing with respect to the value based on said criterion.

In certain cases, the way the criteria are represented is modified so to have inputs that are compatible with the decision model.

An example of modification is the elimination of superfluous criteria or criteria too noisy to be exploitable or the application of a transformation based on certain criteria in order to ensure the monotonicity of the output of the decision model.

The second point determined is the nature of the problem to be solved.

The initial problem is one of the following problems: choosing the best alternative from a set of alternatives, distributing alternatives among preference classes, ranking alternatives in an order of preference, and providing an evaluation score for an alternative. The nature of the problem to be solved is thus the choice, the distribution, the storage or the evaluation.

The problem of distributing alternatives among preference classes is a sorting problem.

The problem of arranging alternatives in an order of preference is an automatic ranking problem.

The problem of providing an evaluation score to an alternative or of choosing the best alternative from a set of alternatives is a problem consisting of giving each alternative a satisfaction score. Such a problem is often referred to as a scoring problem. When a scoring problem is solved, it is possible to address a ranking problem without needing further information, since the calculated score can be used for ranking alternatives from the best to the worst.

Similarly, when a scoring problem is solved, it is possible to solve a sorting problem, provided there is further information on the threshold value. An alternative then belongs to a class when the score thereof is between two thresholds.

The third point is to obtain the training data.

According to the example described, the training data are data from sensors and are thus measurements.

Training data are usually heterogeneous in the sense that training data come from a plurality of sources (herein, a plurality of sensors) and are of different natures.

In particular, the training data can be represented in pairs.

Three types of pairs can be envisaged.

According to a first type, one pair is an (x, y) pair where x is an alternative and y is the score that the alternative is supposed to have (expected score).

According to a second type, one pair is a, (x, k) pair where x is an alternative and k is the index of a preference class (e.g. “good”, “bad” and “average”).

According to a third type, one pair is an (x1, x2) pair where the two elements are alternatives, with x1 an alternative which is preferred by the decision-maker to the x2 alternative.

Because of the heterogeneous nature thereof, obtaining training data in certain cases involves the use of pre-processing which ensures that even if the data are represented differently, the data represent reality in the same way and use the same criteria for evaluating the alternatives.

Heterogeneity can come from the fact that such training data can be collected at different times and come from different people—each person providing a type of data.

In a second phase, the decision model as such is defined.

With the help of the expert e.g. the designer henceforth focuses on defining the model per se. As a particular example, the expert will build with the designer of the model the hierarchy of criteria, define the artificial criteria resulting from the aggregations, choose if he/she wants the aggregation class at each node and the nature of the utility functions applied to each of the criteria, if the functions are necessary.

More specifically, in certain cases, the decision-maker can have a priori certainties. The decision-maker e.g. can consider that he/she knows in advance the utility function of a part of the native criteria, the parameters of certain of the aggregations (or of the constraints on certain of said parameters). It is then possible to efficiently implement such constraints, and to set the utility functions so that same are not learned, and on the contrary are defined “by hand” depending on the wishes of the decision-maker.

Similarly, in certain cases, the way in which the criteria are organized hierarchically is set in advance by a decision-maker. The hierarchy can indeed correspond to a logical organization according to a decision-maker—the intermediate aggregation nodes between the criteria and the final aggregation node then correspond to concepts which make sense to a decision-maker.

It will be understood that the generation method does not necessarily need as many elements of information on the initial problem.

In certain cases, it is sufficient to know the criteria, the nature of the initial problem and the training data.

The generation method includes a supply step E50, a transcription step E52, a training step E54, a determination step E56 and a physical installation E58.

In the supply step E50, the initial problem and the training data are supplied.

To this end, the system receives the information which has, most often, been developed by interactions between the decision-maker and the designer, although such interactions are not mandatory.

Moreover, in the example proposed, it is assumed that, during the supply step E50, the system further receives a hierarchy of criteria.

At the end of the supply step E50, the system thus knows the initial problem and the hierarchy of criteria while having a set of training data.

During the transcription step E52, the initial problem is transcribed in the form of a neural network and a set of constraints to be satisfied by the neural network.

The transcription step E52 thus aims to convert the initial problem and the hierarchy of criteria into a neural network and a set of constraints to be satisfied by the neural network.

In the present method, the neural network has a specific architecture for which FIG. 3 illustrates a particular example.

Thus, the transcribed neural network includes a set of neural sub-networks.

More precisely, the neural network comprises a set of neural sub-networks arranged according to a specific structure, each neural sub-network being a first neural sub-network or a second neural sub-network.

In the proposed example, a first neural sub-network is an aggregation sub-network.

A first neural network is a sub-network implementing an aggregation function.

An aggregation function A is a function defined by a utility vector and returning a real aggregation value.

Let N={1, . . . , n} be the set of criteria (attributes in the vocabulary of the decision support field).

X is the domain of the i-th criterion.

An alternative is defined as an element of X=X₁ x . . . . X Xₙ.

A decision model is a function U: X->[0,1], which is usually called a utility function inducing a total order on X. Utility functions are often represented in a decomposable form, namely U(x)=A(u₁(x₁), . . . uₙ(xₙ)) with uᵢ being the marginal utility function, u; being a function of Xᵢ in the interval [0,1].

In the present case, the above means that the aggregation function A associates values of the set [0,1]ⁿ with a value in the set [symbol] , and if normalized, in the interval [0,1].

More precisely, the aggregation function is a function defined on a utility vector a=(a₁, . . . , aₙ) which returns an aggregated value in the interval [0,1].

According to the proposed example, the aggregation function belongs to the family of Choquet integrals.

A Choquet integral is a generalization of the weighted sum, which also takes interactions between criteria into account.

The Choquet integral is parameterized by a fuzzy measure p which is used for assigning a certain weight to each of the coalitions of criteria (where a weighted sum has only one weight per singleton).

By definition, a fuzzy measurement p on a set N is a function of 2^{N} in the set [symbol] satisfying a normalization condition and a monotonicity condition.

The normalization condition is that μ(Ø)=0 and that μ(N)=1.

The condition of monotonicity is expressed according to the following relation:

A⊆B⊆N⇒μ(A)≤μ(B)≤1

Thus, the Choquet integral C_{μ}, parameterized by the fuzzy measure μ, of a vector of values a, is written:

C_{μ}(a)=Σᵢ₌₁^{|N|}(a_{τ(i)}−a_{τ(i-1)})μ({τ(i+1), . . . ,τ(n)}).

wherein τ is a permutation in the set N satisfying two conditions a_{τ(i)}≤a_{τ(i+1)} and α₀=0, at the same time.

In the example described, the aggregation function A is a Choquet integral which is a 2-additive integral.

In such a case, only an interaction between at most two criteria is envisaged. In this way it is possible to obtain a satisfactory representation of reality while limiting the number of free parameters. Limiting the number of free parameters facilitates training because the risk of overfitting is limited.

When the aggregation function A is a 2-additive Choquet integral, the aggregation function is written:

$${C}_{μ} ( u ) = {\sum }_{i = 1}^{\vert N \vert} {w}_{i} {u}_{i} + {\sum }_{i = 1}^{\vert N \vert} {\sum }_{j = i + 1}^{\vert N \vert} {w}_{ij , Min} min ( {u}_{i} , {u}_{j} ) + {\sum }_{i = 1}^{\vert N \vert} {\sum }_{j = i + 1}^{\vert N \vert} {w}_{ij , Max} max ( {u}_{i} , {u}_{j} )$$

Where:
wᵢ is the weight of the i-th utility function uᵢ,
w_{ij,Min} is the weight of the minimum interaction between the i-th utility function uᵢ and the j-th utility function uⱼ, and
w_{ij,Max} Is the weight of the maximum interaction between the i-th utility function uᵢ and the j-th utility function uⱼ.

As can be seen in the example shown in FIG. 4 which corresponds to such a first sub-network, the first sub-network of neurons comprises an n-dimensional input layer then a hidden layer and an output layer.

The neurons of the hidden layer each perform one function amongst: identity (if the neural has only one input, the neural returns the input thereof unchanged), min-pooling (the neural has two inputs and returns the value of the smallest of the inputs thereof), or max-pooling (the neural has two inputs and returns the value of the largest of the inputs thereof.) A linear regression on the outputs of all such neurons makes it possible to learn the weights, wᵢ, w_{ij,Min} and w_{ij,Max}.

In a variant, the aggregation function A is a weighted sum of the utility functions.

According to yet another embodiment, the aggregation function A is an ordered weighted average.

Such an operation is often referred to as OWA (Ordered Weighted Averaging).

In a variant, the aggregation function A is a generalized additive independence function.

Such a function is often called GAI (Generalized Additive Independence) function.

Using such a function assumes that the problem is modeled as a utility sum on subsets of criteria which can intersect.

In a variant, the aggregation function A is a multi-linear function.

Such a function is written mathematically according to an expression similar to the previous expression for the case of a 2-additive Choquet integral, the only modification being to replace the functions min and max by a product of the variables, and to add neurons for each of the missing subsets. The use of such model requires the use of multi-dimensional utility functions which can be obtained by a multi-linear interpolation, or by a logit function integrating a multi-linear function of the different input variables.

It should be noted that it is not mandatory that all first sub-networks perform the same aggregation function, each aggregation function being specific to a first sub-network.

The aggregation function is preferentially a variable aggregation function selected from the list consisting of a weighted sum of variables, a Choquet integral, a 2-additive Choquet integral, a weighted sum of combinations of min and max functions between at most k variables, for k being an integer at least equal to 2, a multi-linear model, a generalized additive independence function, and the ordered weighted average.

A second sub-network implements a utility function such as the functions used in decomposable multiple-criteria decision support models.

The role of a utility function is to take as input, the raw value on one of the criteria, and to give as output, the satisfaction provided by the value on said criterion, independent of the values of the alternative on all the other criteria.

The above means that a utility function takes a real number at the input and outputs another real number.

In practice, as in the present example, a second sub-network has as inputs, the raw values of the alternatives on each of the criteria, and outputs the marginal satisfaction that such a value gives to a decision-maker, more particularly on said criterion.

The above means that the second sub-network implements a marginal utility function.

According to the example described, the marginal utility function is normalized between 0 and 1.

The above means that the minimum value of the marginal utility function is 0 and the maximum value of the marginal utility function is 1. In certain cases, the minimum and/or maximum value is reached at the limits.

Thus, according to the example described, a marginal utility function uᵢ is a function of X in the interval [0,1] is a function ensuring a correspondence between the i-th attribute domain Xᵢ over the interval [0,1].

An example of such a second neural sub-network is illustrated in FIG. 5 with a hidden layer comprising 3 nodes.

Generally, marginal utility functions are of two different forms.

According to a first form, the marginal utility function is monotone.

According to a second form, the marginal utility function is a single-plateau function. Such second form is often referred to as “single-plateau”.

By definition, a marginal utility function is according to the second form when the marginal utility function exhibits a single change in monotonicity. Otherwise formulated, the marginal utility function has only two portions: a first portion on which the function is monotone in one direction and a second portion on which the function is monotone in a different direction from the first portion.

With regard to the nature of marginal utility functions according to the second form, it is possible to distinguish between marginal utility functions including a plateau (increasing then decreasing function) and marginal utility functions including a valley (decreasing then increasing function).

As in the case of the first sub-network, it is not mandatory that all the second neural sub-networks perform the same marginal utility function, each marginal utility function being specific to a second neural sub-network.

The marginal utility function is preferentially a monotone function or a function having three parts, a monotone first part, a constant second part and a monotone third part, the monotonicity of the first part being different from the monotonicity of the third part.

According to the example described, the neural network is thus an assembly of sub-networks, more precisely an assembly of sub-networks, each sub-network being chosen from the first sub-network and the second sub-network.

The neural network is an assembly according to a specific structure.

Thus, the neural network includes a set of neural sub-networks arranged in a tree structure, each neural sub-network being a first neural sub-network or a second neural sub-network.

The tree structure is a tree structure when there is a single path between a particular vertex to all other vertices, and each non-leaf vertex has at least two child nodes.

More specifically, in the case described, the tree structure is a structure the leaves of which are the raw inputs of the neural network (most often the available data from the sensors when the decision support system is used under real conditions) and the root is the output of the neural network.

With reference to FIG. 3, the neural network includes at the input thereof, second neural sub-networks followed by a first neural sub-network.

The neural network described includes three second sub-networks followed by a first sub-network of neurons. The outputs of the second sub-networks are three marginal utility functions which are connected by the first neural sub-network which implements a Choquet integral.

According to another example, the neural network includes several first sub-networks.

In general, such a structure enables the neural network to represent the hierarchy of the criteria.

It can be noted that such a structure can be represented mathematically as follows.

s(g) denotes the output of the node g. If g is a leaf, then s(g) will be the image by a marginal utility function of the criterion corresponding to the leaf. Otherwise, if g is a non-leaf node, then g has a plurality of children {g1, g2, . . . , gf}. s(g) is then the image by the aggregation function in g (e.g. a 2-additive Choquet integral) of the vector formed by the outputs of all the children thereof: s(g)=A(g1, g2, . . . , gf) where A is the aggregation function in question.

According to a first example, the structure of the neural network is designed in collaboration with the decision-maker.

According to a second example, the structure of the neural network is chosen by the designer.

To make such a choice, the designer can rely on obvious relationships between variables, tests on a plurality of models to determine the most suitable model for the data, or analyses on variables aimed at revealing particular relationships which can be used (e.g. dimension reduction, strong positive or negative correlations between two variables).

According to a third example, the structure of the neural network is a parameter of the neural network which is learned during the training step E54.

From a functional point of view, the neural network with a tree structure is an aggregation of input criteria for generating new criteria which will be, again, aggregated into a new criterion and so on, until reaching an overall score for the considered alternative.

Such a type of neural network thus implements a decision model by small successive aggregations, which makes it possible to represent certain complex decision strategies, while pruning superfluous terms and parameters which can appear in an overall aggregation of all the criteria.

Other structures are conceivable for the neural network.

Thus, according to one example, the neural network comprises only a first sub-network. In such a case, the neural network implements a classical Choquet integral regression model.

According to another example, the neural network includes at the input thereof, a second neural network layer performing utility functions. A model class can thus be obtained, which authorizes the use of such functions.

The aggregation functions described hereinabove are, for the most part, strongly constrained, in particular by monotonicity. Thus, the Choquet integral is increasing with respect to each of the inputs thereof, and each of the inputs thereof has to be between 0 and 1 (symbolically, marginal satisfactions are aggregated into an overall satisfaction. It is thus necessary that, the higher the satisfaction on a given criterion, the higher the overall satisfaction, all other things otherwise being equal).

Therefore, a Choquet integral cannot be a model compatible with certain raw data (i.e. upstream of the application of a marginal utility). To take the example of the radar, the overall satisfaction has to be decreasing compared to the power consumption, all other things otherwise being equal. The above means that, without the application of a decreasing marginal utility on electricity consumption, the Choquet integral will not be able to satisfactorily aggregate such criterion. On the other hand, after an application of such a decreasing function u which represents the satisfaction on the electrical consumption p, the overall satisfaction is indeed increasing with respect to u(p), all other things otherwise being equal.

Similarly, the fact that the utilities are all at values lying within [0,1], allows the model to have important properties: the commensurability of the criteria (ability to compare satisfactions on a plurality of distinct criteria) in particular. Indeed, it is hard to compare the satisfaction provided by criteria which live within different scales (e.g. the radar range between 10 km and 1000 km, and the power consumption between 1 kW and 1000 kW), and which can be [given] in different units. The utilities thus can be used for a renormalization of all the elements on the same satisfaction scale [0,1]

Thereby, marginal utilities make the raw data “compatible” with the model.

According to yet another example, the neural network includes, at the input, other sub-networks aimed at determining the values of the criteria from input data.

In the proposed example, each sub-network has a number of hidden layers less than or equal to 3.

More precisely, each sub-network is arranged in the form of layers with an input layer grouping together the input neurons and an output layer grouping together the output neural(s). All the intermediate layers are hidden layers which are only linked to the neurons of the layers which are immediately downstream and the neurons of the layer which is immediately upstream.

More generally, each sub-network has a number of hidden layers less than or equal to 5.

As a particular example, each sub-network is a multi-layer perceptron.

In the above sense, the neural network is a set of simple neural networks, each representing a family of aggregation functions or utility functions, which can be interconnected for obtaining models for multiple-criteria decision support.

According to a first example, during the transcription step E52, the set of constraints to be satisfied by the neural network is obtained implicitly. By choosing e.g. an aggregation function, the constraints of the integration function are imposed on the model; an aggregation function e.g. which is a Choquet integral, will be increasing with the inputs thereof, continuous, bounded and idempotent.

According to a second example, the set of constraints is provided explicitly. As an illustration, a decision-maker can decide to constrain the aggregation functions or the utility functions even more, e.g. by forcing certain parameters to be larger than others. The above then requires additional constraints to be set on the aggregation function.

The set of constraints thus includes constraints of monotonicity, derivability, idempotence, and continuity.

The transcription step E52 includes the formulation of the set of constraints to be satisfied by the neural network in the form of sub-constraints to be satisfied by each neural sub-network.

According to the example described and as will be described more precisely with reference to the training step E54, the sub-constraints to be satisfied by a neural sub-network are chosen from the list consisting of:
the monotonicity of the variation of the output of the neural sub-network as a function of the inputs of the neural sub-network,
the output of the neural sub-network being comprised between a minimum value and a maximum value, the output of the neural sub-network being equal to the minimum value when all inputs of the neural sub-network are equal to the minimum value, and the output of the neural sub-network being equal to the maximum value when all the inputs of the neural sub-network are equal to the maximum value, and
each sub-network being suitable for implementing weights, one constraint being that the weights are positive and that the sum of the weights is equal to 1.

In the above sense, with the specific sub-constraint(s), each sub-network forms an autonomous calculation unit independent of the other sub-networks.

At the end of the transcription step E52, a transcribed neural network is thus obtained, such a neural network being a complete network ready to be used for training in order to solve the initial problem.

During the training step E54, training of the transcribed neural network is implemented using the training data.

Otherwise formulated, the network being built and the data being compatible with the implementation of training, it is possible to implement training of the network with the training data.

According to the proposed example, the parameters of the neural network are the weights connecting the neurons of the neural networks and the biases applied to the input value of certain neurons.

As indicated above, in certain cases, the parameters of the neural network include the structure of the neural network.

In any case, even if a piece of information about the neural network is not available, it is still possible to train the neural network, although the network could be less precise.

Training includes the use of at least one technique selected from the list consisting of batch gradient descent, stochastic gradient descent, and mini-batch gradient descent.

Each of the above techniques is a technique or algorithm for training the parameters of each neural sub-network, in particular due to the fact that each sub-network is a multi-layer perceptron.

In general, such techniques consist of reading the training data several times, propagating each of the points forward in the neural network, and propagating the gradients backward (from the output to the input) so as to readjust the parameters of the neural network.

More specifically, the batch gradient descent technique is also referred to as the batch gradient descent algorithm.

The implementation of such a technique includes an adjustment of the parameters in order to minimize a cost function, which quantifies the error between the estimated response and the correct response on training data. The parameters are modified iteratively by subtracting the gradient from the cost function which is calculated by a composition of linear operators or of differentiable isolated non-linearities by averaging over the whole batch, i.e. all the calculated parameters. The implementation of such a technique thus involves successive multiplications of Jacobian matrices.

Stochastic gradient descent (sometimes also called the stochastic gradient algorithm) is an iterative gradient descent technique used for the minimization of an objective function that is written as a sum of differentiable functions. Stochastic gradient descent is less computation-consuming in the sense that same is performed on a single example per iteration, the example being chosen randomly in the database.

The mini-batch gradient descent is a compromise between the two previous techniques by choosing a mini-batch randomly at each iteration and by calculating the gradients on the mini-batch.

In certain cases, the use of the aforementioned techniques leads to training a neural network has no coherence property.

In order to avoid the appearance of such inconsistencies, in the example described, it is proposed to impose constraints—which are the sub-constraints obtained beforehand—to be satisfied locally, i.e. at each sub-network.

The sub-constraints to be satisfied locally are now presented successively for the first sub-network and the second sub-network according to the two forms of marginal utility function to which same corresponds.

For a first sub-network, the training consists of training a fuzzy measurement satisfying the training data and satisfying the two preceding conditions, namely the normalization condition and the monotonicity condition.

According to the proposed example of an aggregation function which is a 2-additive Choquet integral, to learn the fuzzy measurement and in particular the monotonicity property, it is sufficient to guarantee two training sub-conditions, namely that all weights, wᵢ, w_{ij,Min} and w_{ij,Max} are positive and that the sum of all weights, wᵢ, w_{ij,Min} and w_{ij,Max} is equal to 1.

The above actually corresponds to the fulfillment of n² conditions.

The two training sub-conditions e.g. are obtained by performing frequent renormalizations without using any regularization.

Once the property is learned, the first sub-network formally implements a 2-additive Choquet integral, with all the properties expected (e.g. monotonicity, idempotence, continuity).

For a second sub-network and more specifically, a marginal utility function according to the first form, namely a monotone function, the direction of monotonicity is known.

According to the example described, the direction of monotonicity is set by the initial problem, the decision-maker knowing such a direction.

According to the example described, a marginal utility function (monotone, or a monotone part of a single-plateau type marginal utility function) is learned as a weighted sum of sigmoids. A sigmoid is written as the ratio between 1 and the sum of 1 with an exponential.

Furthermore, the weighted sum is normalized so that the sum of the weights is equal to 1, and all weights are positive.

The above is written mathematically as:

$${u}_{i} ( {a}_{i} ) = {\sum }_{l = 1}^{{p}_{i}} \frac{{r}_{i}^{l}}{1 + exp ( {η}_{i}^{l} {a}_{i} - {β}_{i}^{l} )}$$

With:
pᵢ, a hyperparameter setting the maximum number of sigmoids involved in the previous formula,
rᵢ^{l}, the weight associated with the l-th sigmoid,
ηᵢ^{l}, a first constant associated with the l-th sigmoid, the first constant controlling the accuracy of the l-th sigmoid, and
βᵢ^{l}, a second constant associated with the l-th sigmoid, the second constant controlling the bias of the 1-th sigmoid.

Training for such a marginal utility function according to the first form then consists of training each weight and the two constants for each of the sigmoids with two constraints with regard to the weights. According to the first constraint, each weight is positive and according to the second constraint, the sum of the weights is equal to 1.

To this end e.g. the weights of the last layer toward the output are made positive by the use of hidden variables, the weights of which are the image by a positive and increasing mathematical function, and wherein the sum of said weights is made equal to 1 by a renormalization at each iteration.

With such training, it is guaranteed that the marginal utility function is monotone (i.e. according to the first form) and normalized.

For the case of a marginal utility function according to the second form, the nature (plateau or valley) is acquired from the decision-maker.

Thereafter, it is assumed that the marginal utility function is a plateau function.

A transformation is applied to the training data so as to have to learn only the plateaus.

Training then consists of training four values x1, x2, x3 and x4 such that x1<x2<x3<x4 and such that the marginal utility function has the value 0 over the intervals ]-∞; x1] and [x4; [, has the value 1 over [x2; x3] and be a linear interpolation on the intervals [x1; x2] and [x3; x4].

Such training guarantees the form, normalization and the continuity of the marginal utility function according to the second form.

In a variant, the training of a marginal utility function according to the second form is carried out by the training of weighted sums of sigmoids in a direction of monotonicity (as previously for the case of a marginal utility function according to the first form) and then in the reverse direction of monotonicity.

Note that the threshold x* value is also learned, such that the first weighted sum is applied to the left of such point, and the second weighted sum is applied to the right of such point. The value in x* is necessarily 0 (in the case of a valley) or 1 (in the case of a plateau). The above is ensured by renormalizations.

Furthermore, such training can be used for obtaining a function of marginal utility which is derivable. Such a property makes it possible in particular, to facilitate training since the problems of disappearance or explosion of the gradient during training are avoided.

In the end, from an overall point of view, at each iteration, training includes a propagation phase and a backpropagation phase.

The propagation phase is a forward propagation phase consisting of the injection into the leaves, of values on each criterion. The values will then move from sub-network to sub-network, over successive aggregations, until reaching the root, or output node, which will give us the result.

The backpropagation phase consists of comparing the result obtained with the expected result. The backpropagation phase uses a so-called “loss” function which characterizes the difference between prediction and truth. Such a function is a function of the quadratic error which is written L(x,y)=(M(x)−y)² where x is an input alternative, M(x) is the score given to the alternative x by the model M, and y is the expected score. The gradient of the function L is then calculated at the output, then propagated throughout the network, going out to the leaves. As a result, each of the sub-networks calculates the gradients of the loss with respect to its own parameters thereof and updates same before transmitting the gradients to the upstream sub-networks.

It should also be noted that the type of error function to be optimized depends on the type of data (mean square error for regression e.g., or logistic error for binary classification). Any type of differentiable error function can thus be minimized, at least locally.

As an illustration, in the case of training by pairs of preferences, a Siamese architecture is preferred (the network N is duplicated, in order to obtain two “clone” networks N1 and N2 identical to the network N). The error is then an increasing function of (N2(x2)−N1(x1)), (e.g. an arctangent function, i.e. herein a tan(N2(x2)−N1(x1)). The gradients are calculated on the first clone network N1 and the second clone network N2 and are then summed for obtaining the total gradient. The latter is applied to the first clone network N1, then the first clone network N1 is again copied to obtain the new clone network N2.

The E54 training step can be used for obtaining a network of trained neurons solving the initial problem.

The trained neural network performs a function.

During the determination step E56, the function performed by the trained neural network is determined.

More precisely, an explicit form is determined in the form of a compact mathematical formula, which keeps the same parameters (and thus corresponds to exactly the same function as the function the neural network represents).

The determined function is the function corresponding to the compact mathematical formula.

As a particular example, in the case of the 2-additive Choquet integral, the network learns the weights wᵢ, w_{ij_min} and w_{ij_max}. Once the network is trained, the weights are extracted (ignoring all the rest of the parameters), and the weights are used to set the parameters of an explicit 2-additive Choquet integral function (see previous equation). The determined function is thus completely characterized.

The network is thus only a support for training such function, while keeping the explicit parameters thereof. After training, the parameters can be saved, stored, or used as such for parameterizing a function of the same type.

During the implementation step E58, the determined function is physically implemented for obtaining the decision support system.

According to a particular example, the neural network is implemented on an FPGA.

The generation method can be thus used for obtaining an evaluation system implementing the function performed by the trained neural network with a simplified implementation (consuming little resources and memory) so as to make the function compatible with an embedded implementation.

Furthermore, the evaluation system will address the initial problem and assist the decision-maker, especially when the alternatives are modified too frequently to be studied by a human (real-time implementation aspect) or by issuing an alert when an acceptable alternative is, most of the time, no longer acceptable (case of a monitoring application).

The generation method can thus be used for easily and quickly training a complex preference model satisfying strong formal constraints and corresponding to known classes of preference models, or resulting from successive aggregations of models belonging to said classes. Such a preference model is thus a model suitable for assisting a decision-maker in his/her decision-making on a given problem, in particular because the model stays transparent and easy to interpret.

Such properties have been demonstrated experimentally by the applicant during tests.

Moreover, the generation method is a method of neural training of a preference model, which means that the generation method advantageously uses a representation of a problem in the form of a neural network.

In particular, the method can be used for modifying the neural network so as to easily switch from one type of problem to another. It is e.g. easy to move from a regression problem to a classification problem, or even of training preferences from pairs of labeled alternatives, depending on the input data, the nature of the input data, and the expected nature of the output.

Furthermore, training a neural network is a task that can be parallelized. It is thus possible to implement the training step E54 with a hardware architecture suitable for operations performed in parallel.

Thus, the training step E54 is advantageously executed on processors such as CPUs or CPUs. A CPU (Central Processing Unit) is a processor, whereas a GPU (Graphic Processing Unit) is a graphics processor.

According to another variant, the training step E54 is performed on a server farm.

It follows from the previous elements that the generation method can be used for benefiting from the best of both worlds, the world of multiple-criteria decision support with the rigor thereof and the world of machine training with the statistical approach thereof. The generation method is thus part of the field of hybrid artificial intelligence, a field which combines statistical methods of machine training and strong expert constraints integrated into the training models.

The generation method puts to use, the advantages provided by the use of neural networks, namely a high modularity and the absence of the need for manual calculation of complex gradients, while providing strong constraints on the trained model, both due to the particular architecture of the network, and due to the aforementioned normalizations and procedures.

Otherwise formulated, the method hence puts to use, the ability of multilayer perceptrons to regress model parameters from data, and the formal guarantees provided by multiple-criteria decision support aggregation models for training subtle, yet strongly constrained models.

The method thus can be used for generating models suitable for supporting multiple-criteria decision-making, which provides the guarantees on the model that the decision-makers can require in operational frameworks. However, the method further provides the possibility of working on noisy or even erroneous data.

The method further uses the fact that the neural network is divided into two types of sub-networks.

In this way it is possible to obtain a generation method with greater computational simplicity.

Indeed, the methods of the prior art involve calculating a local gradient for each of the possible configurations, which leads in practice to limiting the aggregation in order that the calculation can be performed in practice. In the present method, on the other hand, the gradients are calculated only locally, i.e. aggregation by aggregation.

More precisely, during the training step E54, the training data is propagated from sub-network to sub-network during forward propagation and the gradients are then propagated from sub-network to sub-network during backpropagation. For each sub-network, a simple gradient is thus calculated independently of the complexity of the network as a whole and the calculated gradient is then propagated to the upstream sub-networks.

Such a method provides an easier implementation of the constraints. The sub-networks are defined in such a way so as to ensure that at any stage of the training step E54, the sub-network formally satisfies all the constraints to be satisfied for the function the sub-network performs. The use of adjustments or checking calculations is thus avoided. Constraints are easily fulfilled locally for each sub-network and the fact that constraints are fulfilled by each trained sub-network ensures that the entire trained network fulfills the constraints in an overall manner.

The method further has the advantage of a high modularity since each sub-network can be modified without modifying the entire network. It is possible e.g. to replace a first sub-network with another first sub-network which corresponds to a different aggregation function. A marginal utility module can also be replaced by another. It is also possible to rearrange the sub-networks. However, in such case, it is necessary to re-train the network (or at least the sub-part of the network which has been modified).

Such a possibility is, in particular, relevant in the case of a hierarchy of aggregations. More particularly, it can thus be assumed that, if a large number of classically aggregated cell classes have been trained, finding the right hierarchy is the only remaining problem for adapting the neural network to the situation.

The method can be further used for simpler validations. Indeed, for each sub-network of the same type, which belongs to the same class, it is sufficient to check that the class meets the necessary conditions set out in the training step E54, in order to validate all the sub-networks of the same class. A greater ease of maintenance of the physical implementation of the trained neural network results therefrom.

Other embodiments of the present method are conceivable.

According to a first example of another embodiment, the training step E54 includes a validation of the model.

More precisely, after implementing a training technique as previously proposed, a model is obtained to be validated, the parameters of which are henceforth determined.

The designer then presents to the decision-maker with the model to be validated, i.e. the function that the neural network learns

Such a presentation is e.g. implemented using indicators used in the field of decision support. Shapley values or interaction indices are examples of such indicators. As an illustration, the designer presents a graph plotting the Shapley values of each criterion.

By definition, the Shapley value of each criterion represents the relative importance of the criterion compared to the other criteria. Given a fuzzy measurement p on a set of criteria, the Shapley value of criterion i is calculated as:

$$S ( i ) = {\sum }_{K ⊆ N \backslash \{ i \}} \frac{( n - \vert K \vert - 1 ) ! \vert K \vert !}{n !} [ μ ( K ⋃ \{ i \} ) - μ ( K ) ]$$

The interaction index characterizes the strength of an interaction between two criteria (by the absolute value thereof). The sign of the interaction index indicates whether same is redundancy (negative) or synergy (positive). The index of interaction between criteria i and j is written as:

$$I ( i , j ) = {\sum }_{K ⊆ N \backslash \{ i , j \}} \frac{( n - \vert K \vert - 2 ) ! \vert K \vert !}{( n - 1 ) !} [ μ ( K ⋃ \{ i , j \} ) - μ ( K ⋃ \{ i \} ) - μ ( K ⋃ \{ j \} ) ]$$

According to another example, machine training indicators are used, such as sensitivity analyses, Sobol indices or cross-validation errors.

Sobol indices are alternatives to Shapley values for calculating the proportion of variance expressed by each criterion (another way of defining the importance of each criterion).

Cross-validation is a process aimed at quantifying system performance: a network is trained on 80% of the data, and tested on the remaining 20% (so as to evaluate same on data which were not seen during training). Errors on such data (in addition to the average value thereof, which is already an indicator of the performance of the model), provide information on the model. In particular, if all examples of a certain area of the X-space are misclassified, a weakness of the model in that particular area can be indicated therefrom, which can illustrate a marginal poor utility, or a poor choice of aggregation function.

With the inputs provided by the designer, the decision-maker determines whether the model is valid in light of his or her experience of the actual situation.

When the decision-maker considers that the model is invalid because certain model outputs are wrong, the designer determines how to make the appropriate corrections so as to obtain a valid model.

Such a correction is, according to a first example, a manual correction, i.e. a forced modification of certain parameter values of the trained neural network.

According to a second example, which can be implemented in combination with the first example or alone, data is added to the training data and the training is implemented with the training data thus completed. Such a correction example can be used in particular for repairing possible errors due to erroneous data, or at a zone of the input space under-represented in the original training data.

The process presented (evaluation and correction) can be iterated as many times as necessary until the decision-maker is satisfied with the model obtained.

In certain cases, validation includes the use of quantitative indicators such as cross-validation error instead of the decision-maker satisfaction or in addition to the decision-maker satisfaction via a weighting of the subjective and quantitative evaluation.

According to such a first example of another embodiment, the training comprises the implementation of a supervised training technique.

According to a second example of another embodiment, a training of the hierarchy of criteria is performed. Such an embodiment is relevant in particular, when the decision-maker is not available.

To this end, as an illustration, the training includes a first training with the set of constraints of the transcription, for training an intermediate neural network, a second training of the set of constraints by setting the neural network at the intermediate neural network, so as to obtain a learned set of constraints, and an adjustment of the trained neural network depending on the difference between the set of constraints of the transcription and the learned set of constraints, so as to obtain an adjusted neural network, the trained neural network being the adjusted neural network.

Certain implementations of such an example are described hereinafter.

A first technique is to learn a single layer of aggregation. However, such a layer is over-parameterized, and carries greater risks of overfitting than a model designed with an expert, yet is the most likely to adequately represent the data.

A second technique is to study the data through various unsupervised training algorithms. Interactions can be seen e.g. on correlation/covariance matrices, the directions of utilities can be seen on partial dependency graphs, artificial criteria can be the main components of a Karhunen-Loève transformation. More advanced techniques, such as variational autoencoders, can be applied as well.

Finally, a third technique consists of training the hierarchy via so-called structure learning techniques. The above includes, but is not limited to, evolutionary or genetic techniques, exploration or heuristic research techniques (e.g. beam research). One of the preferred techniques, specific to Choquet integrals, consists of starting from a “flat” model, with a single aggregation and training until convergence. Once convergence achieved, observing the values of interactions between criteria makes it possible to group together the criteria which interact in the same way with all the other criteria, thus generating a new tree. A plurality of candidate trees are thus created, and trained. Only a certain number of best candidates (candidates who do not degrade performance) can then be kept, and training continued until satisfying a chosen stop criterion (e.g. if no new candidate improves performance).

In yet another embodiment, the generation method includes the application of a statistical technique for making more robust, the model implemented by the neural network or techniques of modification of characteristics (principal component analysis, autoencoder, etc.).

According to another variant, the neural network includes pre-processing stages on the inputs or post-processing stages on the outputs.

In a variant or additionally, the neural network includes one or more deep learning sub-networks.

In particular, networks involving training the representation or the selection of features which could thus be used for extracting, from data initially incompatible with the model (an image e.g.), new features (or new criteria) which, in turn, would support decisions made by the decision models as described hereinabove. In such case, the first sub-network or sub-networks serve as an “output block” and thus take decisions on the information pre-processed upstream by the deep networks.

A particular case is the calculation of marginal utility functions which can be applied as “scaling” of native criteria, within the framework of utility models, in order to offer modified variables more suitable for the subsequent aggregations. Hence the marginal utilities and the parameters of the aggregation functions can be learned in parallel by stochastic descent of the gradient.

A person skilled in the art well understands that the generation method can comprise a combination of the preceding features when the features are technically compatible.

1.-10. (canceled)

11. A method for generating a multiple-criteria decision support system, the generation method comprising:
the provision of an initial problem and training data solving the initial problem for particular cases, the initial problem being a problem of evaluating the quality of an existing system or of a system to be created, where the initial problem is a problem chosen from:
the choice of the best alternative among a set of alternatives,
the distribution of alternatives among preference classes,
the storage of alternatives in order of preference, and
the provision of an evaluation score of an alternative,
the transcription of the initial problem in the form of a neural network and of a set of constraints to be satisfied by the neural network, so as to obtain a transcribed neural network,
the training of the transcribed neural network using the training data, so as to obtain a trained neural network solving the initial problem,
the determination of the function performed by the trained neural network, and
the physical implementation of the function determined to obtain the decision support system.

12. The generation method according to claim 11, wherein the transcribed neural network includes a set of neural sub-networks, the transcribing step including the formulation of the set of constraints to be satisfied by the neural network in the form of sub-constraints to be satisfied by each neural sub-network.

13. The generation method according to claim 12, wherein each neural sub-network includes hidden layers, the number of hidden layers being less than or equal to 5.

14. The generation method according to claim 13, the number of hidden layers is less than or equal to 3.

15. The generation method according to claim 12, wherein the sub-constraints to be satisfied by a neural sub-network are selected from the list consisting of:
the monotonicity of the variation of the output of the neural sub-network as a function of the inputs of the neural sub-network,
the output of the neural sub-network being comprised between a minimum value and a maximum value, the output of the neural sub-network being equal to the minimum value when all inputs of the neural sub-network are equal to the minimum value, and the output of the neural sub-network being equal to the maximum value when all the inputs of the neural sub-network are equal to the maximum value, and
each sub-network being suitable for implementing weights, one constraint being that the weights are positive and that the sum of the weights is equal to 1.

16. The generation method according to claim 11, wherein the transcribed neural network includes a set of neural sub-networks arranged in a tree structure, each neural sub-network being a first neural sub-network or a second neural sub-network,
each first neural sub-network performing a respective aggregation function, and
each second neural sub-network performing a respective marginal utility function.

17. The generation method according to claim 16, wherein the aggregation function is a variable aggregation function selected from the list consisting of:
a weighted sum of the variables,
a Choquet integral,
a 2-additive Choquet integral,
a weighted sum of combinations of min and max functions between k variables, for k at least equal to 2,
a multi-linear model,
a generalized additive independence function, and
the ordered weighted average.

18. The generation method according to claim 16, wherein the marginal utility function is a monotone function or a function having three parts, a monotone first part, a constant second part and a monotone third part, the monotonicity of the first part being different from the monotonicity of the third part.

19. The generation method according to claim 11, wherein the training includes:
a first training with the set of constraints of the transcription making the training of an intermediate neural network possible,
a second training of the set of constraints by setting the neural network to the intermediate neural network, so as to obtain a trained set of constraints, and
an adjustment of the trained neural network according to the difference between the set of constraints of the transcription and the trained set of constraints, so as to obtain an adjusted neural network, the trained neural network being the adjusted neural network.

20. The generation method of according to claim 11, wherein the training comprises employing at least one technique selected from the list consisting of batch gradient descent, stochastic gradient descent and mini-batch gradient descent.

21. The generation method according to claim 11, wherein the training comprises the use of a weighted sum of sigmoids.

22. A decision support system generated by implementing a generation method according to claim 11.

23. A multiple-criteria decision support system comprising a physical implementation of a neural network comprising a set of neural sub-networks arranged in a tree structure, each neural sub-network being a first neural sub-network or a second neural sub-network,
each first neural sub-network performing a respective aggregation function, the aggregation function preferentially being a variable aggregation function selected from the list consisting of:
a weighted sum of the variables,
a Choquet integral,
a 2-additive Choquet integral,
a weighted sum of combinations of min and max functions between k variables, for k at least equal to 2,
a multi-linear model,
a generalized additive independence function, and
the ordered weighted average, and
each second neural sub-network performing a respective marginal utility function, the utility function preferentially being a monotone function or a function having three parts, a monotone first part, a constant second part and a monotone third part, the monotonicity of the first part being different from the monotonicity of the third part.

24. The multiple-criteria decision support system according to claim 23, wherein the aggregation function is a variable aggregation function selected from the list consisting of:
a weighted sum of the variables,
a Choquet integral,
a 2-additive Choquet integral,
a weighted sum of combinations of min and max functions between k variables, for k at least equal to 2,
a multi-linear model,
a generalized additive independence function, and
the ordered weighted average.

25. The multiple-criteria decision support system according to claim 23, wherein the marginal utility function is a monotone function or a function having three parts, a monotone first part, a constant second part and a monotone third part, the monotonicity of the first part being different from the monotonicity of the third part.
